(19) United States
(12) Patent Application Publication
(10) Pub. No.: US 2022/0088812 A1
(43) Pub. Date: Mar. 24, 2022

(54) IMPROVED RAZOR AND RAZOR HANDLE ASSEMBLY

(71) Applicant: RAZATECH PTY LTD, North Paramatta (AU)

(72) Inventor: Rod HUNWICK, North Paramatta (AU)

(21) Appl. No.: 17/425,413

(22) PCT Filed: Jan. 24, 2020
(86) PCT No.: PCT/AU2020/050047

§ 371 Date: Jul. 23, 2021

(30) Foreign Application Priority Data
Jan. 24, 2019 (AU) 2019900223
Feb. 25, 2019 (AU) 2019201306
Apr. 12, 2019 (AU) 2019901275

(51) Int. Cl. B26B 21/52; B25G 1/08; B26B 21/22

(52) U.S. Cl. CPC B26B 21/522; B26B 21/225; B25G 1/08; B26B 21/521

(57) ABSTRACT

A razor and a razor handle assembly are disclosed that provides greater control when shaving. The razor includes a substantially spherical handle to which a razor head including one or more blades is attached, the handle having a diameter between about 1¼ and 2 inches and a distance between the razor head and the handle is no greater than half a width of the razor head. The razor is sized and shaped to enable the spherical handle to be held in a palm of a hand of a user in a first configuration such that finger tips of that hand are able to apply pressure directly to the razor head, and held in the second configuration between a thumb and finger tips of the user such that the razor may be rotated around at least two axes through relative movement of the user's fingers and thumb.

### TECHNICAL FIELD

The present invention relates to razors for shaving. In particular, although not exclusively, the present invention relates to safety razors.

### BACKGROUND ART

It is common practice in many parts of the world to shave. This may be to remove facial hair, under arm hair, leg hair, or other hair on the body. Most commonly, disposable (or partly disposable) safety razors are used to shave. These safety razors generally comprise a razor head, including one or more blades, from which an elongate handle extends at a right angle to the head.

FIG. 1 illustrates an example of one such safety razor 100, according to the prior art. The razor 100 includes a razor head 105 comprising a plurality of blades 110, the razor head attached to an elongate handle 115. In use, the user grips the handle with his or her hand 120, and thereby drawn across the skin in a shaving motion.

As the body, and in particular the face, is not uniform in shape, the user must generally twist his arm or wrist to enable the blades 110 to engage with the skin at an appropriate angle. The wrist is limited in its movement, and as such it is generally difficult to hold the razor 100 such that the blades 110 engage with the skin at an appropriate angle.

Several attempts have been made to alleviate this problem, including the incorporation of pivoting means 125 between the head 105 and the handle 115, to enable into the head 105 to conform to a shape of the user.

A problem with such pivoting means 125 is that they add further separation between the user's hand 120 and the blades, which is already distant due to the long handle 115, which can make it more difficult for a user to precisely control the location and pressure of the blade relative to the skin. In particular, as the angle of the head 105 pivots relative to the handle 115, the user loses control of the angle of the blade.

Furthermore, the pivoting means 125 are generally biased towards a central (resting) position, and as such, the amount of pressure on the skin is much dependent on the strength of the biasing of the pivoting means 125 rather than a pressure applied by the user's hand 120.

Accordingly, users are still cutting themselves shaving, getting razor burn, or otherwise not able to shave with a desired level of control.

A further problem with pivot head razors, such as the razor 100, is that they comprise a large number of individual parts, which results in a complicated assembly, and are generally expensive to manufacture.

As such, there is clearly a need for an improved razor and razor handle.

It will be clearly understood that, if a prior art publication is referred to herein, this reference does not constitute an admission that the publication forms part of the common general knowledge in the art in Australia or in any other country.

### SUMMARY OF INVENTION

The present invention is directed to razors and razor handle assemblies which may at least partially overcome at least one of the abovementioned disadvantages or provide the consumer with a useful or commercial choice.

With the foregoing in view, the present invention in one form, resides broadly in a razor including a substantially spherical handle to which a razor head including one or more blades is attached, the substantially spherical handle having a diameter about a width of the razor head and located proximate to the razor head such that a distance between the razor head and the handle is no greater than half a width of the razor head, the razor sized and shaped to enable the razor to be held in first and second configurations, the spherical handle being held in a palm of a hand of a user in a first configuration such that finger tips of that hand are able to apply pressure directly to the razor head, and the spherical handle being held in the second configuration between a thumb and finger tips of the user such that the razor may be rotated around at least two axes through relative movement of the user's fingers and thumb.

Advantageously, the handle of the razor provides greater control over the razor and the ability to rotate and pivot the razor head, in an ergonomic manner. As a result, shaving quality is improved, and the likelihood of cuts and razor burn is reduced.

The configuration of the razor enables it to be held at least two different ways. When the handle is held in the palm of a hand, the fingers of that hand may extend over handle such that fingertips of those fingers engage with, and are able to apply pressure to, a back side (rear) of the razor head, and thereby accurately control a pressure of the razor to the skin. When the spherical handle is held between the fingertips, rotation of the spherical handle around different axes may be used to provide controlled movement to the razor head.

A handle that is not proximal to the razor head is not able to provide such controlled movement, as the razor head would be too far from the head to enable such fingertip control, and a long handle would magnify small movement of the spherical handle, reducing control of the razor head.

Reference to the width of the razor head is the width from one end of the head to the other end of the head, and corresponds to a cutting width of the razor head.

Reference to the fingertip means the inside of the distal phalanx (i.e. distal most joint of the hand), which extends from one side of the nail to the other side of the nail, and is the area of the finger commonly used to take fingerprints.

The razor head may include a substantially planar rear support surface, adapted to allow the finger tips to apply pressure directly to a rear of the razor head. The rear support surface may comprise fingertip control portions. The fingertip control portions may comprise planar pads. The razor may be configured to enable use of the fingertip control portions with one or more fingers, while one or more other fingers are used to hold the handle.

The handle may be adapted such that the thumb and fingers engage with opposite sides of the handle in the second configuration.

The rear support surface may include one or more apertures, grooves, ribs, protrusions or depressions, to assist in preventing the fingertips from slipping on the rear support surface.

The rear support surface may include one or more apertures, and the apertures may be configured to enable a flow of water through the razor head, to thereby assist in rinsing the razor head.

The apertures may form elongate grooves on the rear support surface.

The razor head may be wedge-shaped in cross section, such that the planar rear support surface is angled relative to the cutting surface of the razor head.

A mounting portion may extend outwardly from the handle, connecting the razor head to the handle.

The mounting portion may comprise an arm.

The mounting portion may be at least partly flexible. The mounting portion may include one or more arms coupling the razor head to the handle. The one or more arms may be flexible.

The mounting portion may extend outwardly from the handle in a direction orthogonal to a surface of the handle.

The razor head may be releasably mounted to the handle by the mounting portion.

The razor head may be mounted transversely to the mounting portion, and angled such that the leading edge of the razor is closer to the handle than a trailing edge. The razor head may include an elongate axis that is orthogonal to an axis of the razor head. The razor head may be angled by rotation around the elongate axis.

The handle may be separable to provide access to an inside thereof.

The handle may include a shaving brush on an inside thereof.

The handle may include a base portion and a lid portion.

The lid portion may function as a brush.

The handle may comprise upper and lower hemispherical portions.

The razor may include one or more magnets configured to retain the upper and lower hemispherical portions in a joined configuration.

The razor head may be removable. The razor head may be configured to be stored in the handle.

The razor head may include a connector which is substantially uniform in cross section and is received in a corresponding aperture of the razor handle. The connector may be directional. The connector may have a Z-shaped cross section.

The at least two axes include at least two of roll, yaw and pitch, or a combination or combinations thereof.

The razor head may include a plurality of blades. The blades may provide parallel cutting edges. The razor head may include a protective edge, configured to provide protection between the blade and the skin.

The handle may be at least about 3 cm (or about 1¼ inch) in diameter and less than about 5 cm (or about 2 inches) in diameter.

The razor head may be less than about 3 cm (or about 1¼ inch, or about 1 inch) from the spherical body.

Preferably, the razor head is less than about 5 cm (or about 2 inches) from the spherical body. The razor head may be less than about 3 cm or 2 cm (or about 1 inch or about ¾ inch) from the spherical body.

The width of the razor head may be about 4 cm (or about 1.5 inches).

The handle may include gripping portions. The handle may include a gripping surface.

The handle may include a surface for printing thereon, e.g. advertising or branding. The handle may include a printed surface thereon, e.g. advertising or branding.

The head may comprise a replaceable cartridge. The razor may be configured to receive disposable cartridges of two or more types. As such, the razor may be multi-fit.

In another form, the invention resides broadly in a razor handle assembly to which a razor head is configured to be attached, the razor handle assembly including a substantially spherical handle, the substantially spherical handle having a diameter about a width of the razor head and located proximate to the razor head when installed, such that a distance between the razor head and the handle is no greater than half a width of the razor head, the razor sized and shaped to enable the razor to be held in first and second configurations, the spherical handle being held in a palm of a hand of a user in a first configuration such that finger tips of that hand are able to apply pressure directly to the razor head, and the spherical handle being held in the second configuration between a thumb and finger tips of the user such that the razor may be rotated around at least two axes through relative movement of the user's fingers and thumb.

A razor may be provided by attaching a razor head to the razor handle assembly.

In another form, the invention resides broadly in a razor including a substantially spherical handle to which a razor head including one or more blades is attached, the substantially spherical handle having a diameter about a width of the razor head and located proximate to the razor head such that a distance between the razor head and the handle is no greater than half a width of the razor head, the razor including a substantially planar rear support surface, adapted to allow the finger tips to apply pressure directly to a rear of the razor head while the spherical handle is held in a palm of a hand of a user.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a safety razor, according to the prior art.

FIG. 2 illustrates a front upper perspective view of a razor, according to an embodiment of the present invention.

FIG. 3 illustrates a rear upper perspective view of the razor of FIG. 2.

FIG. 4 illustrates a lower perspective view of the razor of FIG. 2.

FIG. 5a illustrates the razor of FIG. 2, in use in a first configuration.

FIG. 5b illustrates the razor of FIG. 2, in use in a first configuration.

FIG. 6 illustrates a front upper perspective view of a razor, according to an alternative embodiment of the present invention.

FIG. 7 illustrates a side view of the lid portion of a handle of the razor of FIG. 6, according to an embodiment of the present invention.

FIG. 8 illustrates a side view of a razor, according to an embodiment of the present invention.

FIG. 9 illustrates a side view of a razor, according to an embodiment of the present invention.

FIG. 10 illustrates a front view of razor, according to an embodiment of the present invention.

FIG. 11 illustrates an enlarged view of a portion of the razor of FIG. 11, illustrating a razor spacer thereof.

FIG. 12 illustrates a top view of a razor, according to an embodiment of the present invention.

FIG. 13 illustrates a side view of the razor of FIG. 12.

FIG. 14 illustrates a side view of a razor, according to an embodiment of the present invention.

FIG. 15 illustrates a side view of a razor, according to an embodiment of the present invention.

FIG. 16 illustrates a side view of a razor, according to an embodiment of the present invention.

FIG. 17 illustrates a side view of a razor, according to an embodiment of the present invention.

FIG. 18 illustrates a schematic of a razor system, according to an embodiment of the present invention.

FIG. 19 illustrates a top view of a razor of the razor system of FIG. 24.

FIG. 20 illustrates a razor system, according to an embodiment of the present invention.

FIG. 21 illustrates a rear perspective view of a razor according to an embodiment of the present invention.

FIG. 22 illustrates a side view of the razor of FIG. 21.

FIG. 23 illustrates a rear perspective view of a razor head of the razor of FIG. 21.

FIG. 24 illustrates a lower portion of the razor of FIG. 21.

FIG. 25 illustrates an exploded view of the razor of FIG. 21.

FIG. 26 illustrates a rear perspective view of a razor head according to an alternative embodiment of the present invention.

FIG. 27 illustrates a rear view of the razor head of FIG. 26.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

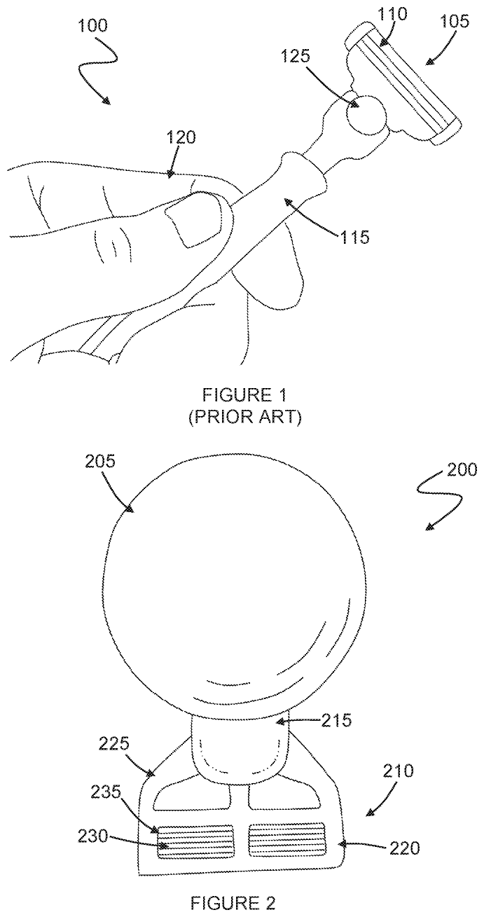

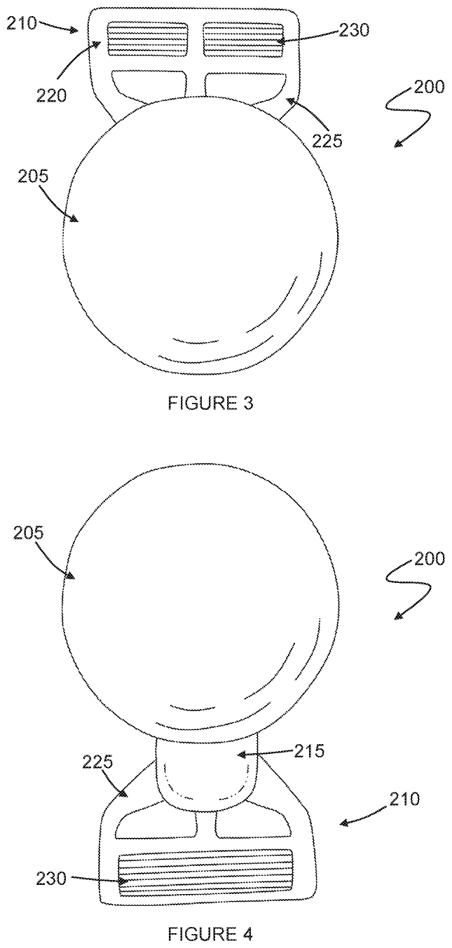

FIG. 2 illustrates a front upper perspective view of a razor 200, according to an embodiment of the present invention. FIG. 3 illustrates a rear upper perspective view of the razor 200, and FIG. 4 illustrates a lower perspective view of the razor 200. The razor 200 includes a spherical handle 205, to which a razor head 210 is attached.

Advantageously, the razor 200 is arranged to provide greater control, including the ability to provide fingertip control to the razor head, and the ability to rotate and pivot the razor 200 in an ergonomic manner.

The razor head 210 includes a mounting portion 215, which extends outwardly from the spherical handle 205 and in a direction orthogonal to a surface of the handle 205. A blade retaining portion 220 is coupled to the mounting portion 215 by a plurality of flexible arms 225, such that the blade retaining portion 220 is able to flex relative to the mounting portion 215 and thus the handle 205 when pressure is applied to the razor head 210.

The razor head 210, and in particular the blade retaining portion 220 includes a plurality of blades 230, configured to provide parallel cutting edges for use in shaving. The head 210 also functions as a guide and a protective edge between the blade and the skin, to enable the blades 230 to come into close proximity with the skin, while preventing or reducing the likelihood of accidental cuts. As such, the razor 200 functions as a safety razor.

The blades 230 are arranged such that the cutting edges are transverse to the direction in which the mounting portion 215 outwardly extends. As such, each of the blades 230 is configured to shave in series, and may be configured to be of varying height from the skin in use, to provide a more comfortable shave.

The razor head 210 includes drainage apertures 235 on a rear thereof, to enable the blades 230 to be rinsed, and for hair to flow out from between the blades. This is particularly important when multiple blades 230 are provided in close proximity, as otherwise a build-up of hair and/or grime may occur, preventing the razor 200 from functioning correctly.

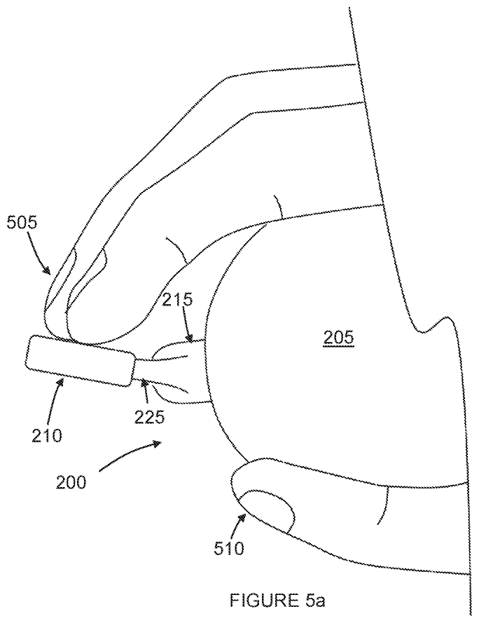

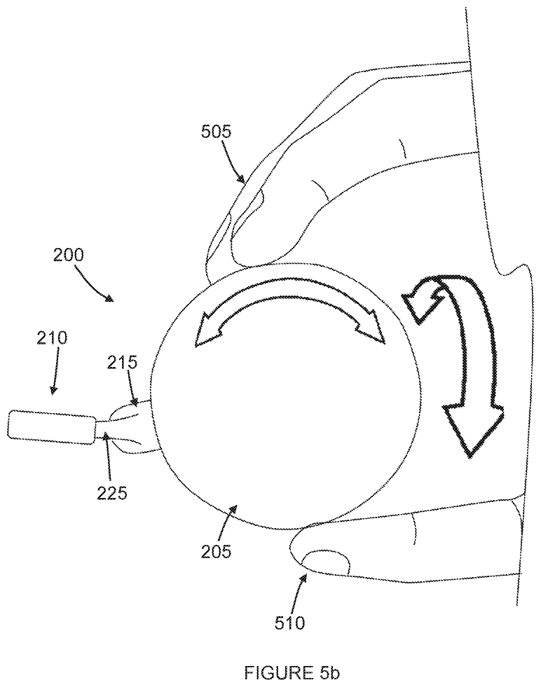

The razor 200 is sized and shaped such that 1) the razor handle 205 can be supported in the palm of the hand of a user while fingertips of that hand apply pressure directly to the razor head (as illustrated in FIGS. 5a), and 2) the razor handle 205 be held between the thumb and finger tips of a user such that when held in such manner the razor may be rotated around at least two axes through relative movement of the user's fingers and thumb (as illustrated in FIG. 5b).

Now referring to FIG. 5a, the razor 200 is held such that the razor handle 205 is supported in the palm of the hand. The spherical handle 205 is particularly suited for such purpose due to its size, and the spherical shape is comfortable as it has no sharp edges.

Depending on a size of the user's hand, the razor handle 205 may be supported in the palm by the thumb and pinky finger, and need not actually be in contact with a significant amount of skin of the palm of the hand (or at all). In other words, the razor head can be supported in the palm of the hand by the thumb and pinky finger, and in proximity to the skin of the palm of the hand without actually touching the palm.

The user's index and middle fingers extend over the handle 205 such that the fingertips of those fingers engage with, and are able to apply pressure to, a back (rear) side of the razor head 210, and thereby accurately control a pressure of the razor to the skin.

The fingertips contain some of the densest areas of nerve endings in the body and are thus a rich source of tactile feedback. As such, rich sensory information is provided from the fingertips and their direct interaction with the razor head 210 (i.e. immediately adjacent to the blades), which enables better control of pressure, which is particularly important around sensitive areas, such as the lips. This is in clear contrast to prior art razors, where the fingertips control the razor head through some type of handle. In such case, a pressure of the razor to the skin is harder to control and harder to sense.

Furthermore, when the fingertips are positioned directly on the back (rear) of the razor head, the hand and brain is able to function in an instinctive, intuitive and natural manner, rather than through a learned (and unnatural) manner as is the case for a stick razor, where there is not only separation between the razor blades and fingers, which magnifies small movements, but also a difference in angle between the fingers and the razor head, which requires clearly conscious and learned movements.

The blades 230 are positioned such that their cutting edge is transverse to the user's fingers when placed on the back (rear) of the razor head 210, and in a direction such that the blades are configured to cut with downwards movement of, and pressure from, the fingers. Such configuration enables the blades 230 to function as an extension of the user's fingertips. This enables the sensitivity of the fingertips to be utilised in a manner that mimics almost directly contact with the skin.

While two fingers 505 are illustrated, the skilled addressee will readily appreciate that a similar configuration may be used where only a single finger (e.g. the index finger) applies pressure to the razor head, or when multiple (e.g. 3 or 4) fingers applies pressure to the razor head.

Now referring to FIG. 5b, the handle 205 is adapted to be held between the index and middle fingers 505 on one side, and the thumb 510 of the user on the other side, such that the user's fingertips engage with the surface of the handle 205. The thumb 510 and fingers 505 engage with opposite sides of the handle 205, which enables relative movement of the fingers 505 and thumb 510 to be translated into rotational movement of the handle in any direction. As such, the razor 200 may be rotated around multiple axes.

As an illustrative example, the fingers 505 may be moved to one side relative to the thumb 510 to rotate the razor 200 around an axis of the mounting portion 215 (and thus rotating the razor head 210). Similarly, the fingers 505 may be moved forward or backwards relative to the thumb 510 to rotate the razor 200 such that the razor head 210 pivots up and down.

As outlined above, the finger tips are a rich source of tactile feedback. As such, the spherical handle 205 and its proximity to the razor head 210 enables extremely accurate control and manipulation of the razor head 210 (and thus blades 230) relative to the skin. As the handle 205 is located in proximity to the razor head 210, more accurate control is facilitated, and accuracy and feedback is not lost through an elongate handle or the like.

In many cases, the razor will be held by the body 205 such that the cutting edge of the blades 230 is transverse to the user's fingers. Such configuration may enable shaving through movement of the user's hand, wrist and/or arm, and/or relative movement of the fingers 505 and thumb 510 (e.g. moving the fingers 505 forward relative to the thumb 510) to cause the razor head to move along the skin in its cutting direction.

However, as the handle 205 is spherical in shape, it may be placed between the fingers 505 and thumb 510 with the blades in another (i.e. any) direction, and manipulated in the same way, as the sphere has the same shape regardless of rotation. As an illustrative example, the handle 205 may be held between the fingers 505 and thumb 510 such that a comfortable movement (e.g. back and forward movement of the fingers 505 relative to the thumb 510) may correspond to a desired movement of the razor head 210 (e.g. rotation or the razor head 210, or movement of the razor head along a curved path).

Holding the handle 205, e.g. as illustrated in FIG. 5b, enables the razor to be used in a manner that provides rotation in multiple degrees of freedom through simple movement of the fingertips. In particular, the razor can be rotated around one axis through forward and backward movement of the fingers relative to the thumb, and around another axis through side to side movement of the fingers relative to the thumb.

Such freedom of movement is much greater than a stick razor, such as that illustrated in FIG. 1.

As such, the razor 200 is able to be used in multiple ways, including those illustrated in FIGS. 5a and 5b. In use, the user may switch between the different types, e.g. one configuration when shaving one part of the body, and another configuration when shaving another.

In addition to the fine movement provided by the fingers 505 and thumb 510, outlined above, the skilled addressee will readily appreciate that the user's wrist and arm will also be manipulated, particularly for gross movement (e.g. from one side of the face to another). In such case, the fingers 505 and thumb 510 may primarily change a roll, yaw and/or pitch of the blades 230, whereas the arms and wrist primarily provide up-down, left-right and/or in-out movements.

The spherical handle 205 is about the same width as the head 210, which is about 4 cm wide (i.e. side to side), and is located proximal to the head 210. As such, the razor 200 is very compact, which makes it easy to store and transport.

The handle 205 may be formed of any suitable material, including ABS plastic, and may include a coating thereon to provide additional grip to the fingertips of the use. Preferably, the handle is corrosion resistant. The handle 205 may be water resistant, to prevent ingression of water into an inside of the handle 205.

In some embodiments, advertising, branding or other text and/or imagery may be printed on the handle 205. This is particularly advantageous in the context of marketing, as it enables the razors 200 to be sold or given away, while providing significant brand exposure, for the manufacturer of the razor 200 or a third party.

As an illustrative example, a company may provide promotional razors through sporting clubs or other groups, or through marketing or promotional events. Details of the company may be provided on the razor handle, enabling the user thereof to easily obtain replacement cartridges, blades or an entirely new razor.

Similarly, the handle may be provided with branding of another business, of a sporting team, character, film or the like, to enable the user to choose or design a razor that fits well with his or her personality or otherwise to the liking of the purchaser.

An example of another razor including indicia printed thereon is described below.

In some embodiments, part of the handle may be coated in a reflective or mirror-like coating. In particular, a surface of the handle facing the razor head may be coated such that it can be used as a mirror, either while shaving or otherwise, alleviating the need for a bathroom mirror.

The razor may include a suction cup, or other retaining member or members, attached to the handle, to enable the razor to be attached to a mirror, tiles, glass or the like. This is particularly useful in that the razor may be stored in a convenient location (e.g. the wall of a shower) when not in use, without cluttering shelves, drawers or other similar places.

The handle 205 may be configured to float in water (which is particularly useful in a bathtub, and may be soft, such that it bounces (rather than cracks) if dropped. Similarly, the razor may be such that it includes a weight such that it balances on its base (i.e. with the blades upwards).

In some embodiments, the handle 205 may be able to be opened, or otherwise utilised (e.g. for storage of shaving cream, or other items). An example of one such razor is described below.

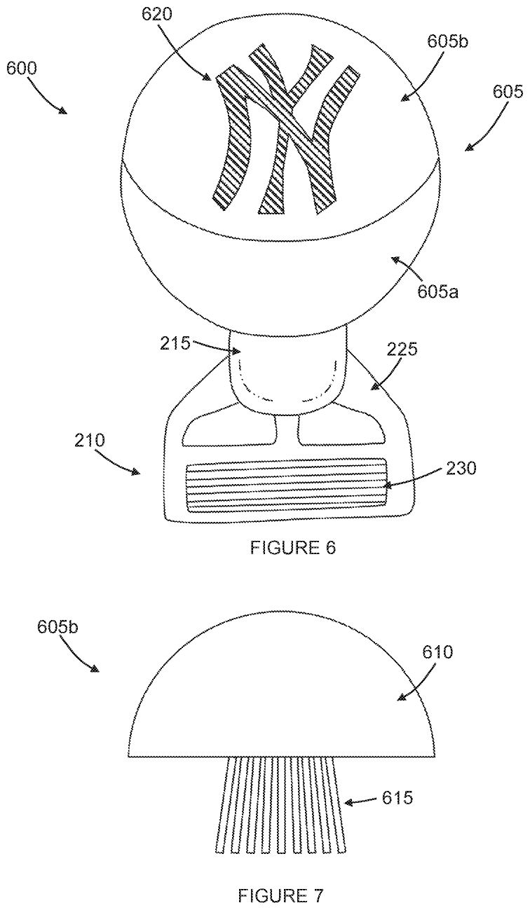

FIG. 6 illustrates a front upper perspective view of a razor 600, according to an alternative embodiment of the present invention. The razor 600 is similar to the razor 200, but wherein the handle 605 is separable to provide access to an inside thereof.

In particular, the handle 605 includes a base portion 605a and a lid portion 605b. the lid portion 605b releasably engageable with the base portion 605a using a press-fit arrangement, threaded engagement or by any other suitable means.

FIG. 7 illustrates a side view of the lid portion 605b of the handle 605, according to an embodiment of the present invention. The lid portion 605b comprises a body 610, from which a plurality of bristles 615 extend. The lid portion 605b thus functions also as a shaving brush.

The body 610 is hemispherical in shape, and the bristles 615 extend downwardly from a lower surface thereof. In some embodiments (not shown), the body 610 may include a reservoir used to store product, such as shaving cream.

The base portion 605a is substantially hollow in shape, and as such, the bristles 615 are able to be received in the base portion 605a without being compressed or deformed, when the lid portion 605b is attached to the base portion 605a.

Now turning back to FIG. 6, the lid portion 605b includes indicia 620 printed thereon, which may be in the form of one or more logos, images, words, brands, decorative patterns or the like, or combinations thereof. As an illustrative example, the razor 600 may include a logo of a favourite sporting team, and may be sold or provided as memorabilia.

Similarly, the indicia 620 may include a website link, which may be used to purchase replacement blades or heads for the razor 600. In one such scenario, the razor 600 may be subsidised (or provided free of charge), with a view of raising money from the sale of blades or razor heads. This enables a manufacturer of the razor 600 to more easily get razors into the market, creating a demand for replacement heads.

In alternative embodiments (not shown), the base portion 605a and the lid portion 605b may provide a receptacle for storing replacement blades or cartridges. In particular, the head 210 (or part thereof) may be replaceable, and the receptacle may include one or more replacement heads. Similarly, the blades 230 may be replaceable and the receptacle may include replacement blades.

In one embodiment, the razor 600 is configured to receive a plurality of different types of disposable cartridges. In such case, the razor 600 may be multi-fit, in that it enables multiple cartridges of different types to be used.

In another embodiment, the razor 600 may be adapted to be such that the handle 605 is able to receive and store the razor head 210 when not in use. In such case, the razor head may detach from the razor for storage in the handle, whereby in such configuration the razor 600 may be substantially spherical. This is useful from a transportation and storage perspective, particularly as the razor is less likely to catch on clothing or other objects.

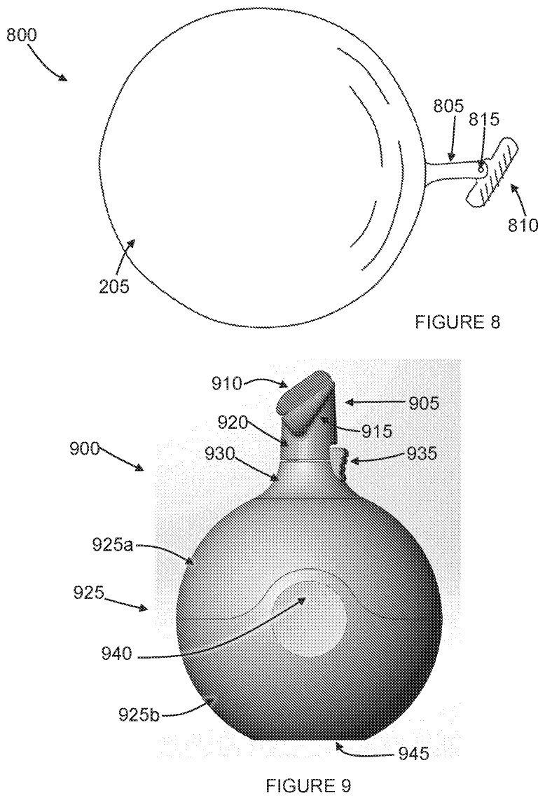

FIG. 8 illustrates a side view of a razor 800, according to an embodiment of the present invention. The razor 800 is similar to the razor 200 and 600, but is configured to use disposable cartridges.

The razor 800 includes a handle 205, and a mounting portion 805, much like the mounting portion 215, but with an engagement portion 815, which enables disposable cartridges 810 to be releasably attached. In particular, the mounting portion 805, which extends outwardly from the handle 205, includes the engagement portion 815 at a distal end thereof, which releasably engages with a corresponding engagement portion of the cartridge 810.

The engagement portion 815 may comprise one or more press-fit members, locking members, or retainers, configured to engage with corresponding members of the cartridge.

In one embodiment, the mounting portion 805 is releasably engaged with the handle 205, which enables the mounting portion 805 to be removed and replaced. This is particularly advantageous in that it enables different types of razor heads to be used with the razor 800.

While the handle 205 has been disclosed as being spherical in shape in the above embodiments, the skilled addressee will readily appreciate that other similar stubby (i.e. short and thick) shapes may be used. As an illustrative example, the handle may be spheroidal in shape. Similarly, the handle may be substantially convex in shape. Alternatively, or additionally, the handle may be axially symmetrical.

FIG. 9 illustrates a side view of a razor 900, according to an embodiment of the present invention. The razor 900 is similar to the razor 200, 600 and 800.

The razor includes a razor head 905 comprising a plurality of blades 910 on a front (cutting) side, the head including a fingertip control portions 915 on a rear (back) side of the razor head 905. The razor head 905 is integrally formed with a mounting portion 920, which is configured to space the razor head 905 from a spherical handle 925.

The mounting portion 920 is releasably coupled to the spherical handle 925 by a head portion 930, which is shaped such that the spherical handle 925 flows smoothly to the mounting portion 920 (i.e. without sharp edges).

The razor 900 includes a locking member 935, which releasably engages with the mounting portion 920 to thereby enable the mounting portion 920 to be released from the handle 925.

The mounting portion 920 extends outwardly from the handle 920, and the razor head is mounted transversely to the mounting portion 920, and angled towards one side. The razor head 905 is wedge-shaped, such that the fingertip control portions 915, which are substantially planar, are angled relative to the surface of the blades 910.

The handle 925 comprises upper and lower portions 925a, 925b, which releasably engage with each other to enable the handle 925 to be opened. In particular, the upper and lower portions 925a, 925b mutually engage, and tab portions 940 may be pressed to disengage the upper and lower portions 925a, 925b.

Finally, the lower portion 925b has a planar bottom 945, which enables the razor to be self-standing on a support surface, such as a bench.

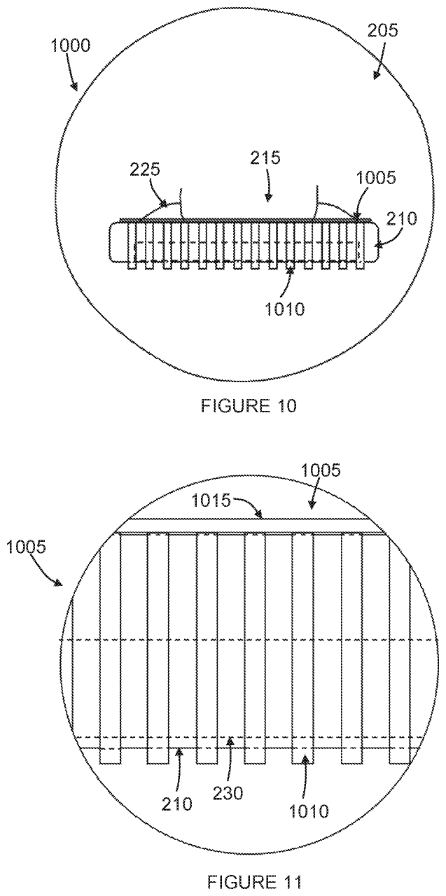

FIG. 10 illustrates a front view of razor 1000, according to an embodiment of the present invention. The razor 1000 is similar to the razor 200, but includes a razor spacer 1005 configured to space the blades 230 from the user's skin. The spacer 1010 enables the user to shave his beard short, such as to a length corresponding to a one to four-day growth (<1.5 mm).

FIG. 11 illustrates an enlarged view of a portion of the razor 1000 illustrating the razor spacer 1005. In particular, the razor spacer 1005 includes a plurality of teeth 1010 which extend downwardly from a support 1015. The teeth 1010 extend downwardly past the edge of the blades 230, and thereby function to space the user's skin from the blades 230.

As the razor 1000 is drawn across the user's skin, the teeth 1010 function much like a comb, enabling the razor 1000 to travel across and through a beard, while enabling the blades 230 to cut the beard to the desired length, defined by the spacer 1005.

The spacer 1005 may be removable, enabling the razor 1000 to function just like the razor 200. In such case, the support 1015 may be adapted to clip onto the head of the razor using one or more retaining members. Similarly, a variety of spacers 1005 may be provided having different length teeth 1010, enabling the user to select a spacer according to the desired length.

In an alternative embodiment (not illustrated), the spacer 1005 may include a mechanism to enable the teeth to be adjust in length. This may be achieved using a dial-like mechanism, which raises and lowers the support 1015 (and thereby the teeth) relative to the head (and thereby blades).

The spacer 1005 may be configured to be able to fit multiple heads, thus enabling the spacer to work on a variety of wet razors, including wet razors of the prior art. As such, the spacer 1005 may be retrofitted to existing razors to enable such new functionality to be provided to the existing razor.

The spacer 1005 is particularly useful in that it allows users to retain some length to their beard (generally very short), while wet shaving, and without requiring electric clippers or the like.

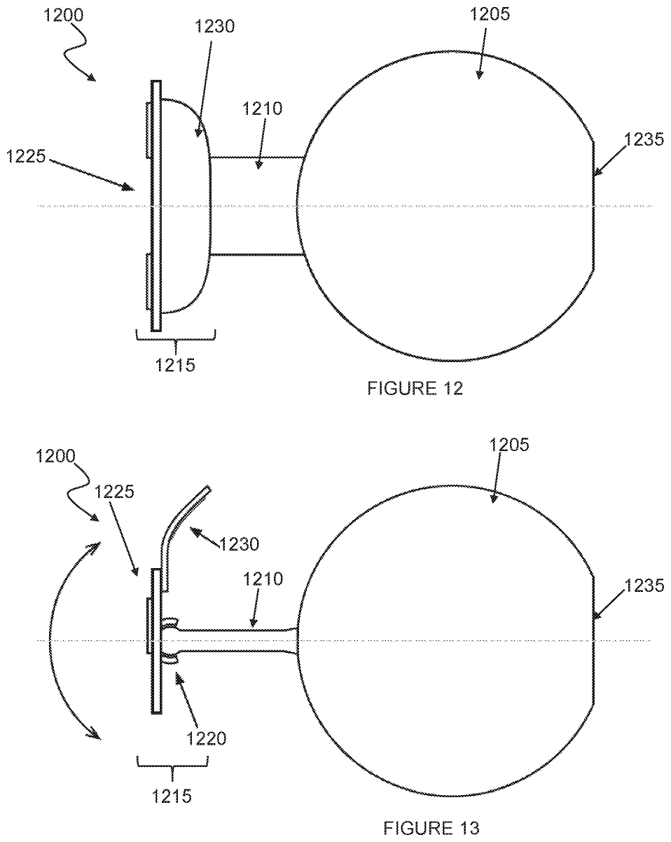

FIG. 12 illustrates a top view of a razor 1200, according to an embodiment of the present invention. FIG. 13 illustrates a side view of the razor 1200. The razor 1200 is similar to the razor 800, and fingertip control portions are configured to also control pivoting of the razor head.

The razor 1200 includes a handle 1205, similar to the handle 205, from which an arm 1210 outwardly extends and with a razor head assembly 1215 on an end thereof. The arm 1210 and the head assembly 1215 include a pivot mechanism 1220 which enables the razor head assembly 1215 to pivot relative to the arm 1210 and thus the handle 1205.

The razor head assembly 1215 includes a substantially planar blade face 1225, to which one or more razor blades are to be attached. The face 1225 may be configured to receive a razor cartridge comprising a plurality of blades, enabling the blades to be replaced as needed.

A control face 1230 of the razor head curves upwardly and inwardly over a portion of the arm 1210 from an upper edge of the blade face 1225, and includes fingertip pads on an inside thereof to enable the user to control a pivoting of the razor head assembly 1215 (and thus any blades attached thereto), by applying pressure to the fingertip pads. In particular, the user may use his or her fingertips to apply pressure to the control face 1230 on an inside of the head 1215 to cause the head 1215 to pivot. The razer head assembly 1215 may be spring loaded, or biased such that when pressure is no longer applied to the control face 1230, the head returns to a default position.

Finally, the handle 1205 is spherical in shape, but includes a flat side 1235, on an opposite side of the handle 1205 to which the arm 1210 extends, which enables the handle to function as a self-supporting stand for the razor 1200 on a surface, such as a benchtop.

In use, the user may hold the razor 1200 in a similar manner to the razor 200 as illustrated in FIG. 5a, however where the fingertips are positioned on the control face 1230, and relative movement of the fingertips relative the rest of the hand (that is holding the handle) will change an angle of the razor head assembly 1215 in addition to controlling a pressure against the skin.

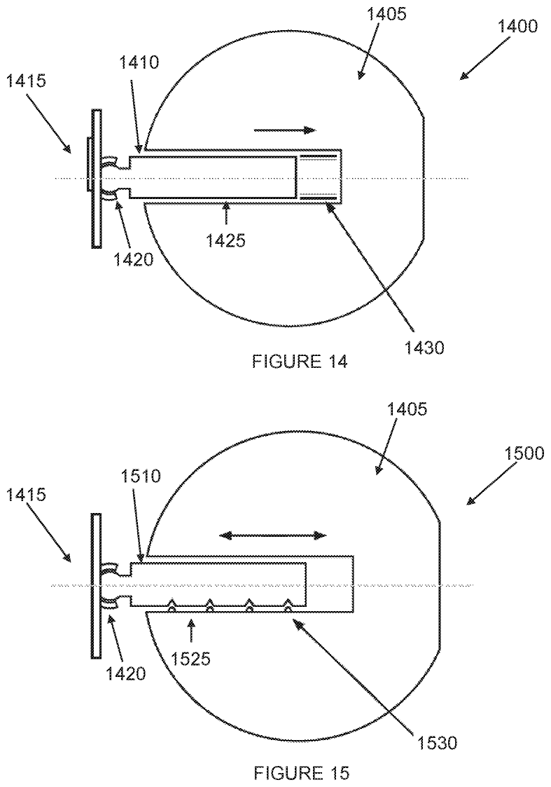

FIG. 14 illustrates a side view of a razor 1400, according to an embodiment of the present invention. The razor 1400 is similar to the razor 1200, but with a spring-loaded adjustable length arm.

The razor 1400 includes a handle 1405, similar to the handle 1205, from which an arm 1410 outwardly extends and with a razor head assembly 1415 on an end thereof. The arm 1410 and the head assembly 1415 include a pivot mechanism 1420 which enables the razor head assembly 1415 to pivot relative to the arm 1410 and thus the handle 1405.

The arm 1410 is received within a channel 1425 of the handle 1405, and a spring 1430 biases the arm 1410 outwards. As such, when pressure is applied to and released from the head 1415 the arm is able to move inwards and outwards thereby providing dampening to forces applied to the razor head.

FIG. 15 illustrates a side view of a razor 1500, according to an embodiment of the present invention. The razor 1500 is similar to the razor 1400, but with notched arm providing multiple fixed length settings.

The razor 1500 includes a handle 1405 from which an arm 1510 outwardly extends and with a razor head assembly 1415 on an end thereof. The arm 1510 and the head assembly 1415 include a pivot mechanism 1420 which enables the razor head assembly 1415 to pivot relative to the arm 1510 and thus the handle 1305, in the same way as the razor 1400.

The arm 1510 is received within a channel 1525 of the handle 1405, which includes a plurality of ribs 1530 placed along a length of the channel, which engage with corresponding notches of the arm 1510. As such, the notches and ribs 1530 enable the arm 1510 to extend outwardly from the handle 1405 at predefined positions.

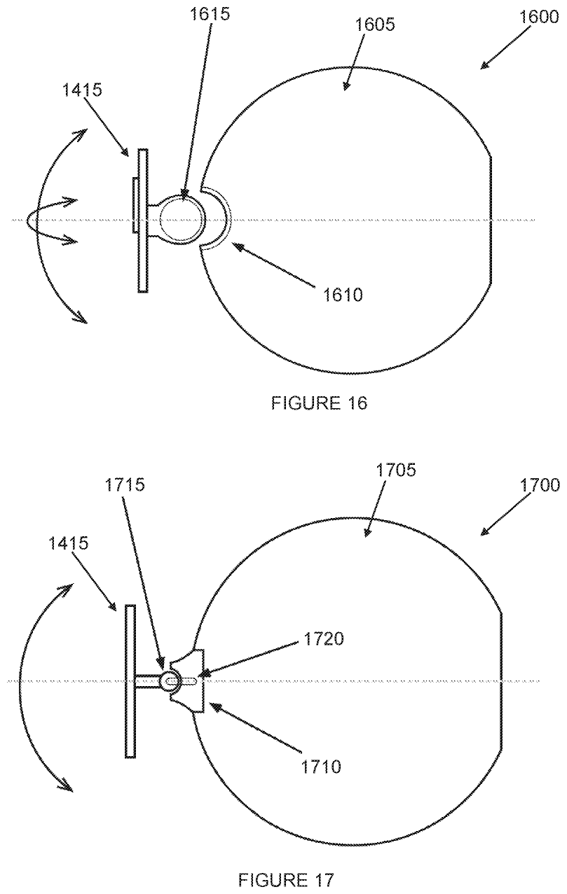

FIG. 16 illustrates a side view of a razor 1600, according to an embodiment of the present invention. The razor 1600 is similar to the razors described above, but includes a spherical, magnetized pivot assembly in place of the arm and pivot.

The razor 1600 includes a handle 1605, which defines a cup portion 1610 for receiving a corresponding ball portion 1615 of a razor head assembly comprising a razor head 1415 attached to the ball portion 1615.

The cup portion 1610 and the ball portion 1615 are each magnetised and with opposite polarity such that the ball portion 1615 is attracted to, and connects to the cup portion 1610. The ball portion 1615 is spherical in shape, and the cup portion 1610 is correspondingly shaped. This enables the ball portion 1615 and the cup portion 1610 to provide a pivoting arrangement to the head which pivots in multiple directions.

The magnetised portions of the cup and ball portions 1610, 1615 may be arranged such that the bias the razor head 1415 into a particular position. As a result, the razor head may be arranged such that it automatically returns after rotating back to a default position.

While the ball portion 1615 is illustrated as being fixed to the head 1415, the ball portion 1615 may be able to releasably engage with the head 1415 to enable the head to be replaced without replacing the ball portion 1615. Such configuration may be both cost effective and environmentally friendly.

While the ball portion 1615 is illustrated as being fixed to the head, and the cup portion 1610 to the handle, the skilled addressee will readily appreciate that the arrangement may be reversed such that a ball portion is fixed to the handle and a cup portion is fixed to a razor head. Similarly, in some embodiments only one of the cup portion 1610 and the ball portion 1615 need be magnetised, the other being a ferrous material (e.g. iron).

The magnetised pivoting arrangement illustrated above may also be used on an end of a conventional razor handle to provide a convenient means for pivoting the head, in a manner that can be easily separated for cleaning.

FIG. 17 illustrates a side view of a razor 1700, according to an embodiment of the present invention. The razor 1700 is similar to the razor 1600, but is configured such that the razor head only pivots around a single axis.

The razor 1700 includes a handle 1705, which includes a cup portion 1710 for receiving a corresponding ball portion 1715 of a razor head assembly comprising a razor head 1415 attached to the ball portion 1715.

The cup portion 1710 and the ball portion 1715 are each magnetised and with opposite polarity, and the ball portion 1715 is spherical like the razor 1600, but a locking pin 1720, which engages with a corresponding channel of the ball portion 18=715, allows the ball portion 1715, and thus the head 1415, to pivot only around a single axis.

Such configuration may be particularly suited when side-to-side pivoting of the razor head is not desired.

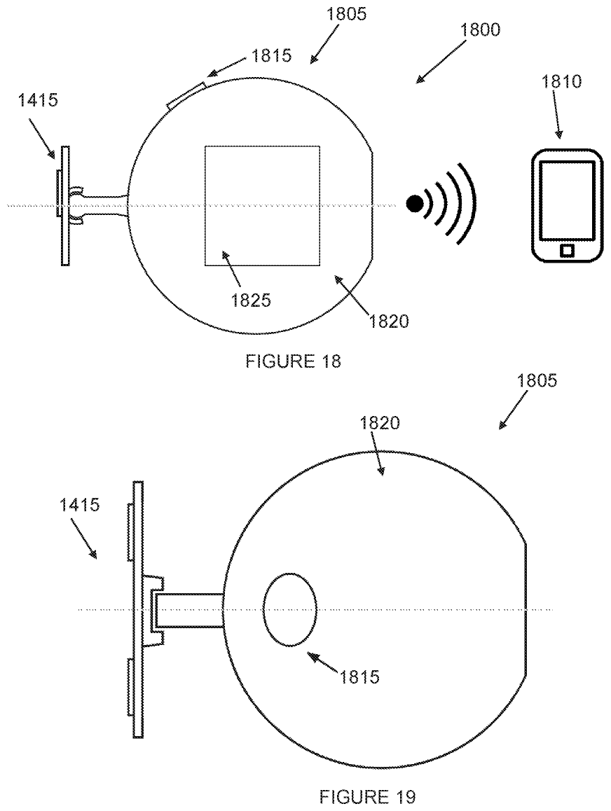

FIG. 18 illustrates a schematic of a razor system 1800, according to an embodiment of the present invention. The razor system 1800 includes a razor 1805 (illustrated in side view), and a portable computing device 1810. FIG. 19 illustrates a top view of the razor 1805.

The razor 1805 includes a camera 1815, mounted on a handle portion 1820 of the razor 1805, which is configured to capture video of the surface being shaved, and send the video to the portable computing device 1810 for display thereon in or near real time. In particular, the razor 1805 includes circuitry 1825, coupled to the camera 1815, and for receiving the image data from the camera, and transmitting the image data wirelessly to the portable computing device.

The razor system 1800 is particularly suited to shaving areas that are hard to see, such as the hair on the back of the persons head, pubic hair, or any other area that is difficult to see. In such cases, the user is able to view that area through the portable computing device 1810, which may be placed in a convenient location.

In some embodiments, the portable computing device may include software which is configured to assist the user in shaving. As an illustrative example, the software may be used to provide guide lines, which is particularly useful when shaping hair. In some embodiments, the guidance may be provided using augmented reality.

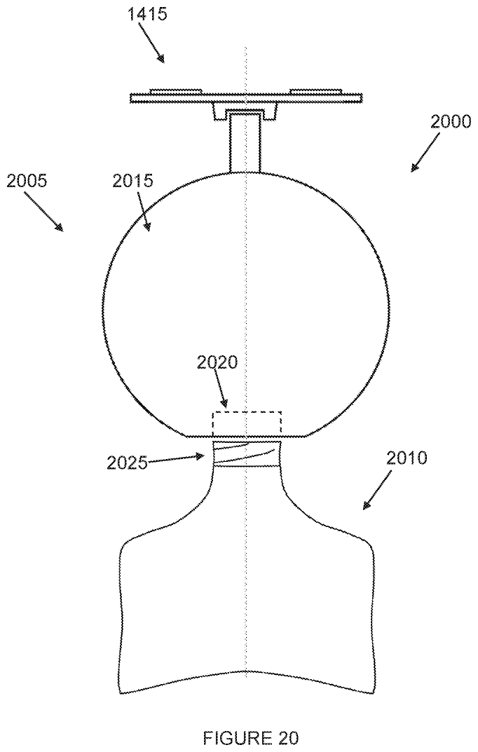

FIG. 20 illustrates a razor system 2000, according to an embodiment of the present invention. The razor system 2000 includes a razor 2005, similar to the razors described above, and a bottle 2010, which engages with a handle 2015 of the razor 2005.

The handle 2005 is spherical in shape, similar to the razors described above, but includes a threaded opening 2020 for receiving a threaded head of the bottle 2010. Such configuration enables the bottle to be attached to the razor 2005 when not in use, and detached from the razor 2005 to provide access to a contents thereof.

The spherical handles described above may include a mechanism to enable the razer head to retract into the handle, e.g. for storage. As an illustrative example, the handle may include a rotating mechanism whereby rotation of the handle causes retraction of the razor head into the handle (or extension out of the handle of rotated the opposite direction). In the storage configuration, the razor may be substantially spherical in shape. Alternatively, the head may simply be detached and stored.

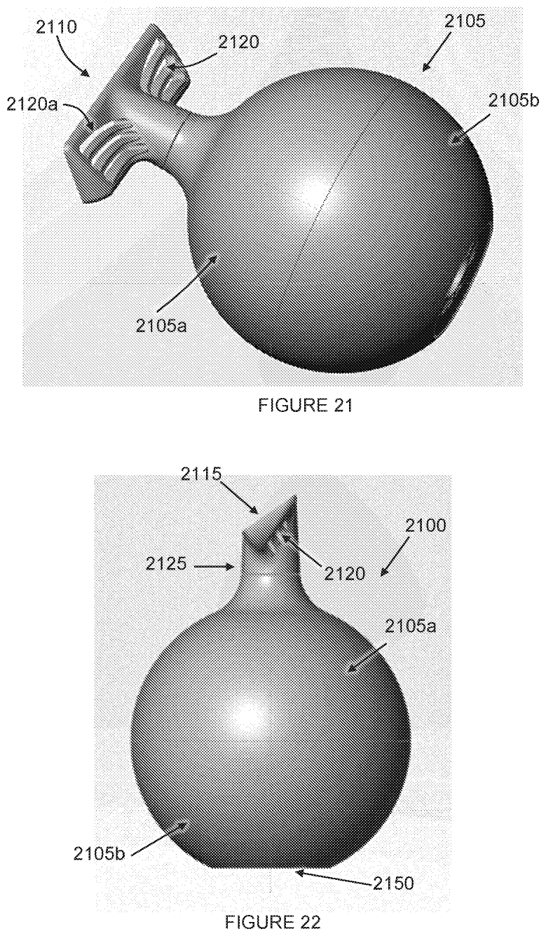

FIG. 21 illustrates a rear perspective view of a razor 2100, according to an embodiment of the present invention. The razor 2100 is similar to the razors described above and includes a spherical handle 2105 to which a razor head 2110 is attached. FIG. 22 illustrates a side view.

The razor 2100, like the earlier described razors, is sized and shaped to enable the razor to be held in first and second configurations, the spherical handle being held in a palm of a hand of a user in a first configuration such that fingertips of that hand are able to apply pressure directly to the razor head (much like as shown in FIG. 5a), and the spherical handle being held in the second configuration between a thumb and finger tips of the user such that the razor may be rotated around at least two axes through relative movement of the user's fingers and thumb (much like as shown in FIG. 5b).

The razor head 2110 comprises a cutting surface 2115 (i.e. blades) on one side (front), and fingertip control portions 2120 on an opposing (rear, back) side. The fingertip control portions 2120 are defined in the rear face of the razor head 2110 and include a plurality of elongate grooves (apertures) 2120a, which function to provide grip to the fingertips, but also to assist in rinsing the blades.

The razor head 2110 includes a mounting portion 2125, which couples the razor head 2110 to the handle 2105, similar to the mounting portion 920. In use, the mounting portion 2125 extends outwardly from the handle 2105. The razor head 2110 extends transversely to the mounting portion 2125 at its end, and is angled towards one side. The razor head 2110 is wedge-shaped in cross section, such that the fingertip control portions 2120, which are substantially planar, are angled relative to the surface of the blades.

The handle 2105 comprises upper and lower portions 2105a, 2105b, which releasably engage with each other to enable the handle 2105 to be opened. The upper and lower portions 2105a, 2105b each include magnets, which enable the portions to join, and be retained together (by way of magnetism), as outlined in further detail below.

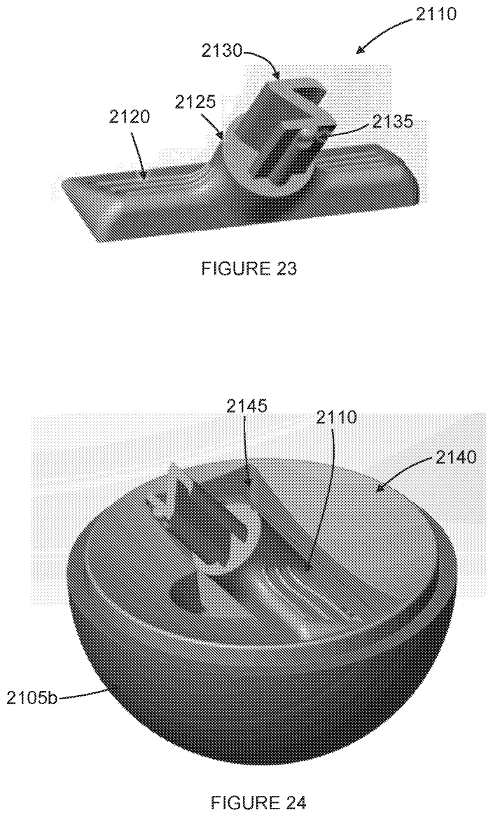

FIG. 23 illustrates a rear perspective view of the razor head 2110. The mounting portion 2125 includes a Z-shaped connector 2130, which is substantially uniform in cross section and is received in a corresponding aperture of the razor handle 2105. The Z-shaped connector simplifies installation, prevents rotation of the head 2110 relative to the handle 2105, and ensures that the head is installed in the right direction. This is particularly important if the handle has information or printing thereon, or if there are gripping portions on the handle.

Near an end of the Z-shaped connector 2130 is a retaining recess, which engages with a corresponding protrusion of the handle 2105, to retain the razor head to the handle in a press-fit style arrangement.

Now turning to FIG. 24, the lower portion 2105b is hemispherical in shape, and includes an insert 2140, which fits snugly in an inside of the lower portion 2105b and defines a receptacle 2145 for receiving the razor head 2110. The receptacle 2145 is shaped to correspond to the razor head 2110, such that the razor head 2110, and in particular a face portion thereof, fits snuggly in the receptacle with the blades facing downwards.

The lower portions 2105b includes magnets, under the receptacle 2145, to retain the razor head in the receptacle 2145, and the upper and lower portions include corresponding magnets that keep the upper and lower portions 2105a, 2105b joined, while enabling separation as needed.

While the receptacle 2145 is illustrated as being substantially rectangular, the receptacle may be shaped to precisely correspond to the shape of the razor head 2110 (or a portion thereof), such that the razor head 2110 snugly fits in the receptacle, such that it is not able to move around and is not loose in any way.

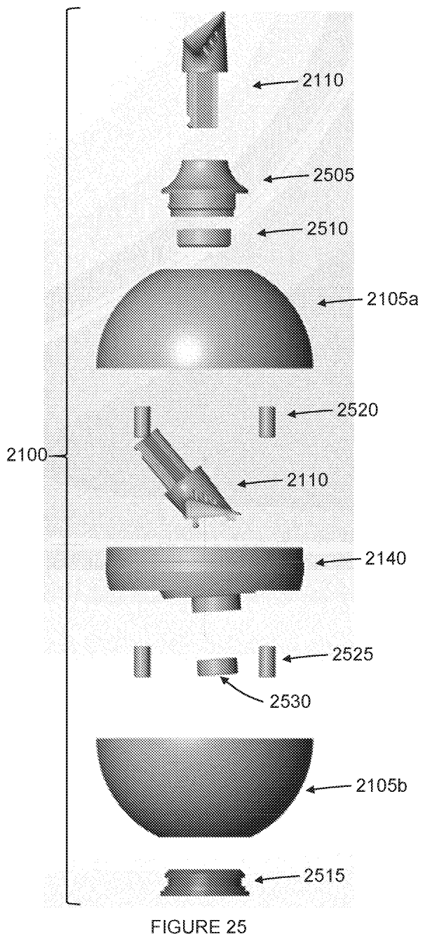

FIG. 25 illustrates an exploded view of the razor 2100, according to an embodiment of the present invention.

As can be seen in FIG. 25, the razor head is coupled to the spherical handle portion 2105a by a head portion 2505, which joins with the spherical handle portion 2105a by a retainer 2510. Similarly, the lower spherical handle portion has a base member 2515 which forms a planar base 2150 of the lower handle portion 2105b, when installed.

First and second upper cylindrical magnets 2520 are retained in a lower portion of the upper spherical handle portion 2105a and correspond to first and second lower cylindrical magnets 2525 which are retained in an upper portion of the lower spherical handle portion 2105b.

The upper and lower portions 2105a, 2105b mutually engage to form the spherical handle 2105. While not illustrated, the upper and lower portions may have engagement members, which assist in engaging the upper and lower portions 2105a, 2105b with each other. As an illustrative example, the engagement members may include guides, which guide the upper and lower portions 2105a, 2105b together in a particular manner, such as by rotation, wherein the magnets may assist in keeping the guides in position.

As outlined above, the razor head 2110 is retained using magnets, and first and second cylindrical magnets 2530 are provided in a base of the retainer 2140 for this purpose.

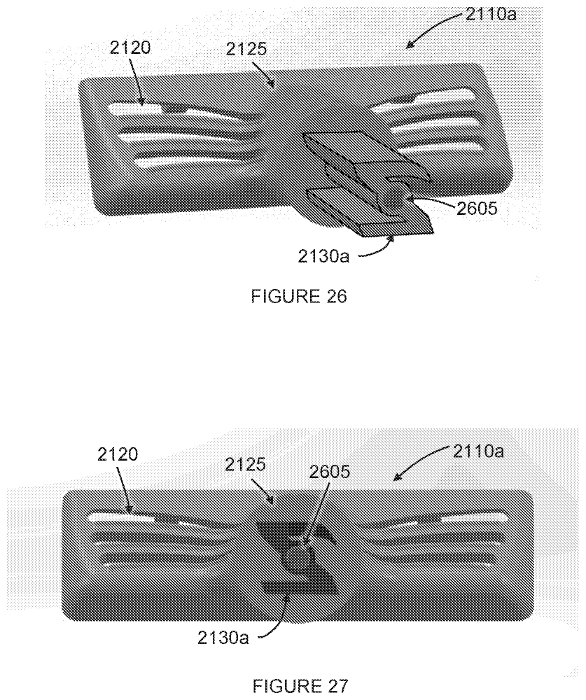

FIG. 26 illustrates a rear perspective view of a razor head 2110a according to an alternative embodiment of the present invention. FIG. 27 illustrates a rear view of the razor head 2110a.

The razor head 2110a is similar to the razor head 2110, but includes a magnetised Z-shaped connector 2130a comprising a retaining magnet 2605 at an end thereof. The retaining magnet 2605 engages with a corresponding magnet in the handle 2105 to thereby retain the head 2110a in the handle 2105.

The skilled addressee will readily appreciate that any reference to magnets, pairs of magnets, or magnets with ferrous counterparts, are interchangeable. As an illustrative example, the pairs of magnets described in the razor head 2110a and body couple be replaced by a single magnet in the head 2110a and a ferrous material in the body 2105, or a ferrous material in the head 2110a and a magnet in the body 2105.

The spherical handles described above may include a rechargeable battery for powering a light, a clock, a media player (e.g. for playing music), or a computer processor. As an illustrative example, the handle may include a processor including one or more sensors configured to determine a use of the razor, and recommend replacement of blades based thereon. The handle may include a display for displaying such information, or may communicate with a smartphone or other device, by Bluetooth, for example.

In one such embodiment, the handle may include a recharge port in a base thereof, to enable the battery to recharge without removal thereof from the handle. The recharge port may comprise a physical port (e.g. a USB type port), or a wireless port for wireless charging. In case of the latter, the battery may be charged by inductive charging from a powered recharge station.

The handles described above are spherical in shape. However, the skilled addressee will readily appreciate that other shapes, substantially spherical, may also be used, including spherical polyhedrons and other sphere-like shapes. In general, the handles may be about as wide as they are high, to enable control around multiple axes. The handles may be about as wide as they are high as they are long.

The spherical handles described above are ergonomic, whether held at the fingertips, or in the palm of the hand, and as such, provide a comfortable grip to the user.

Advantageously, the razors and razor handles described above enable the user to have greater control over the razor, and the ability to rotate and pivot the razor head in an ergonomic manner. The user's fingers are much closer to the blades, increasing interactivity between the user's fingers and the blades.

As a result, the razors and razor handles may provide a closer and more accurate shave, and may decrease the likelihood of accidental cuts and razor burn.

The spherical handle provides a surface suitable printing, including for third-party advertising/branding on the razor.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A razor including a substantially spherical handle to which a razor head including one or more blades is attached, the substantially spherical handle having a diameter between about 1¼ inches and 2 inches and located proximate to the razor head such that a shortest distance between the razor head and the handle is no greater than half a width of the razor head, the razor sized and shaped to enable the razor to be held in first and second configurations, the spherical handle being held in a palm of a hand of a user in a first configuration such that finger tips of the hand are able to apply pressure directly to a rear of the razor head, and the spherical handle being held in the second configuration between a thumb and finger tips of the user such that the razor may be rotated around at least two axes through relative movement of the user's fingers and thumb.

2. The razor of claim 1, wherein the razor head includes a substantially planar rear support surface, adapted to allow placement of the finger tips thereon to apply pressure directly to the rear of the razor head.

3. The razor of claim 2, wherein the rear support surface includes one or more apertures, grooves, ribs, protrusions or depressions, to assist in preventing the fingertips from slipping on the rear support surface.

4. The razor of claim 3, wherein the rear support surface includes one or more apertures, and the apertures are configured to enable a flow of water through the razor head, to thereby assist in rinsing the razor head.

5. The razor of claim 4, wherein the apertures form elongate grooves on the rear support surface.

6. The razor of claim 2, wherein the razor head is wedge-shaped in cross section, such that the planar rear support surface is angled relative to a cutting surface of the razor head.

7. The razor of claim 1, including a mounting portion that extends outwardly from the handle, connecting the razor head to the handle.

8. The razor of claim 7, wherein the mounting portion comprises an arm.

9. The razor of claim 7, wherein the mounting portion extends outwardly from the handle in a direction orthogonal to a surface of the handle.

10. The razor of claim 7, wherein the razor head is mounted transversely to the mounting portion, and angled such that the leading edge of the razor is closer to the handle than a trailing edge.

11. The razor of claim 1, wherein the handle is separable to provide access to an inside thereof.

12. The razor of claim 11, wherein the handle comprises upper and lower hemispherical portions, wherein the razor includes one or more magnets configured to retain the upper and lower hemispherical portions in a joined configuration.

13. The razor of claim 11, wherein the razor head is removable, and is configured to be stored in the handle.

14. The razor of claim 1, wherein the razor head is removable, the razor head including a connector which is substantially uniform in shape in cross section and is received in an aperture of the razor handle of corresponding configuration.

15. The razor of claim 1, wherein the at least two axes include at least two of roll, yaw and pitch, or a combination or combinations thereof.

16. The razor of claim 1, wherein the razor head includes a plurality of blades providing parallel cutting edges.

17. The razor of claim 1, wherein the razor head is less than ¾ inch from the spherical handle.

18. A razor handle assembly to which a razor head is configured to be attached, the razor handle assembly including a substantially spherical handle, the substantially spherical handle having a diameter between about 1¼ inches and 2 inches and located proximate to the razor head when installed, such that a distance between the razor head and the handle is no greater than half a width of the razor head, the razor sized and shaped to enable the razor to be held in first and second configurations, the spherical handle being held in a palm of a hand of a user in a first configuration such that finger tips of the hand are able to apply pressure directly to a rear of the razor head, and the spherical handle being held in the second configuration between a thumb and finger tips of the user such that the razor may be rotated around at least two axes through relative movement of the user's fingers and thumb.

19. The razor handle assembly of claim 18, wherein a razor is provided by attaching a razor head to the razor handle assembly.

20. A razor including a substantially spherical handle to which a razor head including one or more blades is attached, the substantially spherical handle having a diameter between 1¼ inches and 2 inches and located proximate to the razor head such that a distance between the razor head and the handle is no greater than half a width of the razor head, the razor including a substantially planar rear support surface, adapted to allow the finger tips to apply pressure directly to a rear of the razor head while the spherical handle is held in a palm of a hand of a user.
